(19) United States
(12) Patent Application Publication
(10) Pub. No.: US 2017/0234905 A1
(43) Pub. Date: Aug. 17, 2017

(54) MOVEMENT PATTERN GENERATION USING A MOTION DATA GENERATION DEVICE

(71) Applicant: Imagimob AB, Stockholm (SE)

(72) Inventors: Antony Hartley, Taby (SE); Alexander Samuelsson, Stockholm (SE)

(73) Assignee: Imagimob AB, Stockholm (SE)

(21) Appl. No.: 15/500,091

(22) PCT Filed: Aug. 26, 2015
(86) PCT No.: PCT/SE2015/050897

§ 371 Date: Jan. 29, 2017

(30) Foreign Application Priority Data
Aug. 27, 2014 (SE) 1450996-2

(51) Int. Cl. G01P 15/18; G06F 1/16; G06F 3/0346; G06F 17/50

(52) U.S. Cl. CPC G01P 15/18; G06F 17/5009; G06F 1/1694; G06F 3/0346

(57) ABSTRACT

A movement pattern determining arrangement comprises a movement classification device (16) that obtains three-dimensional acceleration vectors (A(x, y, z)) from an accelerometer (14) at regularly recurring times, the movement classification device comprises a group of hit indicating units (20A, 20B, 20C, 20D, 20E, 20F) for processing components of the acceleration vectors in at least one dimension in order to obtain acceleration measures, each hit indicating unit being dedicated to perform processing in a dimension and configured to combine a current acceleration vector component with previous acceleration vector components for obtaining an acceleration measure, compare the acceleration measure with at least one acceleration measure threshold, and indicate a hit if the acceleration measure threshold is crossed, and a pattern handling unit (22) configured to provide a pattern of the hits from all processing being made for the dimensions, which pattern corresponds to a type of movement of the accelerometer (14).

### FIELD OF THE INVENTION

The present invention generally relates to accelerometers. More particularly the present invention relates to a method, a movement pattern determining arrangement, computer program and a computer program product for obtaining a movement pattern associated with a moving entity.

### BACKGROUND

Motion data generating devices like accelerometers and/or gyros are common in a number of portable electronic devices. It is for instance known to provide them in mobile phones.

However, accelerometers are also known to be used in other pieces of consumer electronics, such as step counters. A step counter may also be implemented as an application in a mobile phone

A step counter provides basic motion data in the form of counting the steps taken by a user. However, it may in some cases be of interest to obtain more advanced data that can be used for finer classification of the motion. In the example of steps, the steps may be dancing steps or the steps up and down stairs. It may in some situation be of interest to be able to make a classification of the type of movement based on the measurements made by a motion data generating device. This may be of interest for a number of different fields.

There is therefore a need for enhancing the use of motion data provided by a motion data generating device such as an accelerometer.

### SUMMARY OF THE INVENTION

The present invention addresses this situation. The invention is thus directed towards enhancing the use of motion data. This object is solved through the independent claims 1, 10, 15 and 16.

The invention has a number of advantages. It provides a hit pattern that corresponds to a type of movement by the motion data generating device. Such a pattern can then be used for a number of interesting applications, for instance as a control command into a computer. The invention is also simple to implement. It may be implemented as a piece of software for a processor.

### BRIEF DESCRIPTION OF THE DRAWINGS

The present invention will in the following be described with reference being made to the accompanying drawings, where

FIG. 1 shows a user wearing a portable electronic device comprising an accelerometer and a movement classification device,

FIG. 2 shows a block schematic of the accelerometer and an orientation adjusting unit, pattern handling unit, pattern memory and a number of hit indicating units in the movement classification device,

FIG. 3 shows a first kinematic model that may be used by hit indicating units of the movement classification device,

FIG. 4 schematically shows a second kinematic model that may be used by hit indicating units of the movement classification device,

FIG. 5 shows a flow chart of a number of method steps being performed by the orientation adjusting unit and pattern handling unit of the movement classification device,

FIG. 6 shows a flow chart of a number of method steps being performed by a hit indicating unit of the movement classification device,

FIG. 7 schematically shows an alternative realization of the movement classification device, and

FIG. 8 schematically shows a computer program product in the form of a CD Rom disc for performing functionality of the movement classification device.

### DETAILED DESCRIPTION OF THE INVENTION

In the following, embodiments of the invention providing a movement pattern based on acceleration data from an accelerometer will be described. Such acceleration data is one example of motion data obtained from a motion data generating device that is an accelerometer. Other examples of motion data and motion data generating devices are angular speed data provided by gyros and magnetic field direction data provided by magnetometers.

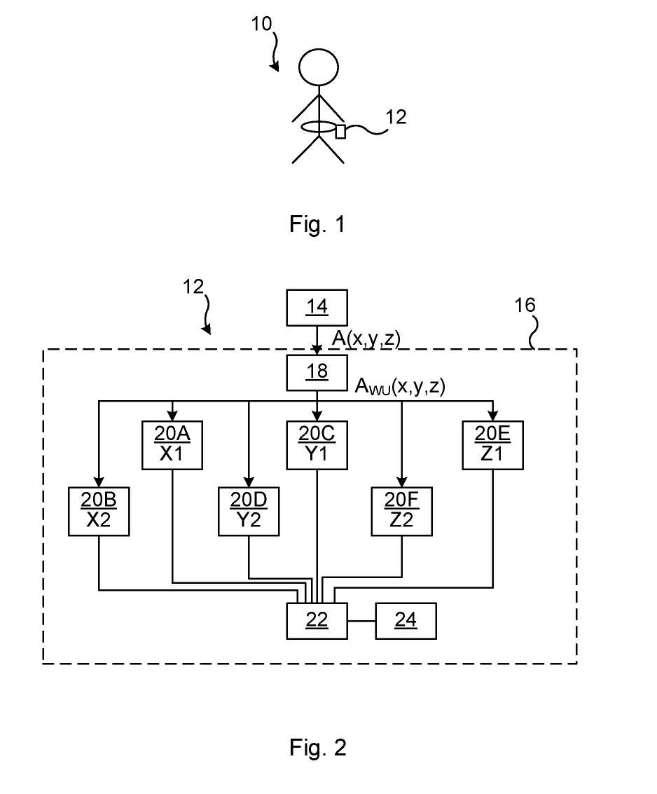

FIG. 1 schematically shows a user 10 who wears a portable electronic device 12. The portable electronic device is one example of a moving entity. In this case the portable electronic device is worn on a belt carried by the user. The portable electronic device 12 comprises a motion data generating device in the form of an accelerometer and may be any type of portable electronic device that compromises such a component. It may for instance be a portable communication device such as mobile phone and with advantage a smart phone. However it may also be another types of device, such as step counter or a portable music player. It should here be realized that the invention is not limited to such a belt or to a portable electronic device for that matter. There is also no limitation to the accelerometer being carried by a user. The accelerometer may also be provided in another entity than a portable electronic device. It may for instance be provided as a part of a vessel, such as a vehicle, or in other consumer goods such as a chainsaw.

FIG. 2 shows a schematic of various blocks in the portable electronic device 12, which blocks are relevant for the present invention. It more particularly comprises the accelerometer 14 as well as a movement classification device 16. The movement classification device 16 comprises an orientation adjusting unit 18, a number of hit indicating units 20A-20F, a pattern handling unit 22 and a pattern memory 24.

The motion data generating device provides three-dimensional motion data at regular recurring times, so-called sampling times, to the orientation adjusting unit 18. This motion data may be considered to comprise a number of three-dimensional motion vectors, As the motion data generating device is an accelerometer 14, the motion data is three-dimensional acceleration data comprising a number of three-dimensional acceleration vectors, where one A(x, y, z) is shown in the figure. The acceleration vector may represent a difference between a current and previous speed detected by the accelerometer.

The orientation adjusting unit 18 in turn rotates the vector to a world up orientation for obtaining a world up acceleration vector A_{WU}(x, y, z). This is done in order to compensate for the accelerometer orientation. The orientation adjusting unit 18 then provides this world up acceleration vector A_{WU}(x, y, z) to a first, second, third, fourth, fifth and sixth hit indicating unit 20A, 20B, 20C, 20D, 20E and 20F. Each hit indicating unit 20A-F is provided for processing a component of the acceleration vector in a dimension. Through this processing the hit indicating unit obtains one or more acceleration measures. There is at least one acceleration measure for every dimension being processed and with advantage two. The first and second hit indicating units are here provided for handling the x-component of acceleration vectors, where they are in essence provided for handling different directions in the X-dimension. The first hit indicating unit 20A may therefore be a first X-dimension hit indicating unit and the second hit indicating unit 20B may be a second X-dimension hit indicating unit. The third and fourth hit indicating units 20C and 20D may be provided for handling the two directions of the y-component of the acceleration vectors and may therefore be a first Y-dimension hit indicating unit and a second Y-dimension hit indicating unit, respectively. The fifth and sixth hit indicating units 20E and 20F may finally be provided for handling the two directions of the z-component of the acceleration vectors and may therefore be a first Z-dimension hit indicating unit and a second Z-dimension hit indicating unit.

Each hit indicating unit then delivers hits that have been determined or indicated in relation to a current received acceleration vector and one or more previously received acceleration vectors in dependence on the fulfillment of a hit criterion set for the vector components. This may more particularly involve processing components of the acceleration vectors in at least one dimension in order to obtain acceleration measures. A hit indicating unit may thus process one component of a number of acceleration vectors for determining or obtaining an acceleration measure, which acceleration measure is compared with at least one acceleration measure threshold. The hit indicating unit then indicates a hit if the threshold is crossed.

The pattern handling unit 22 then receives the hits, where the hits from the group of hit indicating units form a time dependent pattern. It thus receives the hits from all processing being made for the dimensions. The pattern may then correspond to a type of movement of the accelerometer. Therefore, based on the pattern the pattern handling unit may classify the accelerometer to be involved in a corresponding type of movement.

In the example given above, there are two hit indicating units per dimension. In this case the two hit indicating units provided for a dimension may process acceleration vectors independently from one another. It should here be realized that the number of hit indicating units is exemplifying. It is for instance possible that a hit indicating unit is able to indicate hits with respect of both directions in a dimension. In this case there may be only three hit indicating units in order to handle three different dimensions. It is also possible that only two dimensions are used for hit indication, which means that two or four may be used depending on how many directions each hit indicating unit can handle. This may be of interest in some vehicle application. In some cases hit indication may furthermore only be made in relation to one dimension, in which case only two or even only one hit indicating unit may be used. This latter approach may be of interest in defining some basic user movement identification situations. Furthermore, when investigating dimensions, for instance more than one dimension, it is possible that only one direction is investigated in a dimension.

Furthermore the hit indication to be described can be based on combining vector components in one dimension, perhaps with a weighing providing a time decay parameter in order to obtain the acceleration measure and comparing the acceleration measure with an acceleration measure threshold.

One way of obtaining an acceleration measure AM_{D}, could be

AM_{D}=A_{Dt}_{ₖ}e⁻⁰+A_{Dt}_{ₖ₋₁}e^{-(t}^{ₖ}^{-t}^{ₖ₋₁}⁾+A_{Dt}_{ₖ₋₂}e^{-(t}^{ₖ}^{-t}^{ₖ₋₂}⁾

where D denotes the dimension, tₖ indicates a current sampling time, tₖ₋₁ and tₖ₋₂, the most immediate previous sampling times, where tₖ>tₖ₋₁>tₖ₋₂, e^{-(t}^{ₖ}^{-t}^{ₖ₋₁}⁾ and e^{-(t}^{ₖ}^{t}^{ₖ₋₂}⁾ are time decay parameters and A_{D} denotes the component of the acceleration obtained at the time of sampling.

Another possible way to obtain an acceleration measure AM_{D}, may be according to

$${AM}_{D} = {A}_{{Dt}_{k}} + \frac{{A}_{{Dt}_{k - 1}}}{{t}_{k} - {t}_{k - 1}} + \frac{{A}_{{Dt}_{k - 2}}}{{t}_{k} - {t}_{k - 2}}$$

where

$$\frac{1}{{t}_{k} - {t}_{k - 1}} and \frac{1}{{t}_{k} - {t}_{k - 2}}$$

are time decay parameters.

It should be realized that it is possible to also consider even older sampled acceleration components as well as to add various types of constants to the expressions. What may be of importance is that the influence of an acceleration component decreases with age. This means that the older an acceleration component is the lower the influence of this component on the acceleration measure is.

Another possible realization is

AM_{Dt}_{ₖ}=A_{Dt}_{ₖ}e⁻⁰+AM_{Dt}_{ₖ₋₁}e^{-(t}^{ₖ}^{-t}^{ₖ₋₁}⁾

or

$${AM}_{{Dt}_{k}} = {A}_{{Dt}_{k}} + \frac{{AM}_{{Dt}_{k - 1}}}{{t}_{k} - {t}_{k - 1}}$$

In this case a current acceleration measure AM_{Dt}_{ₖ} for a dimension is determined based on a current acceleration vector A_{DT}_{ₖ} and at least one previously determined acceleration measure M_{Dt}_{ₖ₋₁} for the same dimension. The one or more previous acceleration vector components are in this case included in the previously determined acceleration measure. In this case the time decay parameter may be applied on the previously determined acceleration measure. It is then possible to compare the acceleration measure with at least one first acceleration measure threshold AM_{DT1} and perhaps also with a second threshold AM_{DT2} of the dimension in question, in which case the relationship AM_{DT1}=−AM_{DT2} may be used. It should however be realized that the two thresholds can have different absolute values. The threshold levels may thus differ. They would however have different polarities or signs.

In the case of using two hit indicating units for one dimension, then it is possible that only one threshold is used for indicating a hit. However, even in this case the other threshold may be used. It may then be used for inverting the value of the acceleration measure.

A hit may furthermore reset the calculation of acceleration measure. This means that after a hit has been detected or indicated the acceleration measure may be reset.

Another way of indicating hits is through considering the acceleration vector as a force that is applied on a kinematic harmonic oscillation model provided for a dimension. The model then models a body that may have an oscillating motion in relation to a point of equilibrium of the body. The body is thus moved in one or more dimensions by the forces, where these dimensions comprise the dimension being investigated. The movement of the body may thus be in more than one dimension, but the force is only applied in the investigated dimension. The acceleration measure is then related to the movement of the body in more than one dimension. The acceleration measure may then be related to a position of the body, for instance a maximum position in one direction of the oscillating movement.

When such a model is used the processing of the acceleration vectors comprises applying a component of a current acceleration vector as a force on an imaginary mass in the kinematic harmonic oscillation model, and the combining comprises determining the change in movement of the mass in relation to the movement of the mass caused by previous acceleration vector components. A position, such as an end position in the path of the oscillatory movement of the body may then be an acceleration measure being compared with an acceleration measure threshold, which acceleration measure threshold may thus be in the form of an maximum allowed end position. There may therefore be a first stopping point of the mass in the path that is used for providing the acceleration measure. As the motion is oscillatory, there may also be a second stopping point for the mass on the opposite of the point of equilibrium compared with the first stopping point. A stopping point may be realized in various ways depending on which model is being used.

The acceleration measure threshold may then involve the use of also other dimensions than the one investigated. However it may be directly related to or possible to map to the dimension investigated. The processing may therefore be related to the body or mass crossing a movement threshold. Each time the movement crosses a corresponding threshold then a hit is indicated, where the crossing of the first threshold indicates a hit in one direction of the dimension D, while the crossing of the second threshold may indicate a hit for the opposite direction. In such a model the time decay parameter may be a damping parameter of the model.

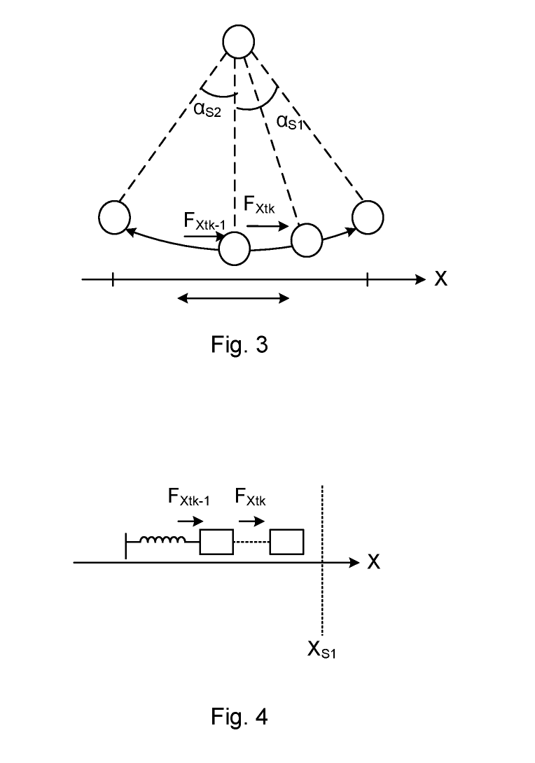

One such model is a pendulum as shown in FIG. 3. The body may be the weight w of a pendulum fixed to a pivot point PP via a string S, which pendulum is set to move in two or perhaps three dimensions. However, only the accelerations or forces in one dimension are acting on the pendulum. The pendulum may be modeled with a certain mass of the weight w, length of the string and damping of the pivot point PP. The threshold used may be provided as a maximum angle or as a distance in the dimensions of the force. In this pendulum model, the first stopping point is realized in the form of a first stopping angle α_{S1} representing a first threshold and the second stopping point is in the form of a second stopping angle α_{S2}, where the first stopping angle α_{S1} is provided from the vertical position of the pendulum in a counter-clockwise direction and the second stopping angle α_{S2} is provided from the vertical position in a clock-wise direction. Further, also here one or both stopping angles may be used for indicating a hit. A hit is then indicated if the swing of the pendulum is so strong that a hit indicating stopping angle is reached. If the first stopping angle α_{S1} is used for indicating a hit, then the reaching of the second stopping angle α_{S2} may be considered as a reflection making the weight w bounce back. The reaching of the first stopping angle will in this case be used to indicate a hit and once a hit is indicated then the pendulum movement can be reset. In FIG. 3 a current force F_{Xt}_{ₖ} is shown as hitting the weight together with a previous force F_{Xt}_{ₖ₋₁}, which together make the pendulum reach the first stopping angle α_{S1}.

Another model is the model in FIG. 4. In this case the force may be applied on a mass m attached to a spring and possibly also to a damper. The mass m may then be moved in one dimension by components of forces F_{Xtd}k and F_{Xt}_{ₖ₋₁} applied in this dimension and if the distance exceeds a threshold distance X_{S1} then a hit is indicated.

These were just a few kinematic oscillatory models that may be used. Countless others exist. However, as can be seen the models are not the models of the behavior of the entity being moved and for which the acceleration data is provided. They are thus not models that are used for modelling the behavior of the accelerometer, but models of virtual or imaginary objects or bodies receiving impacts from one or more forces corresponding to the accelerations of the accelerometer in the investigated dimension.

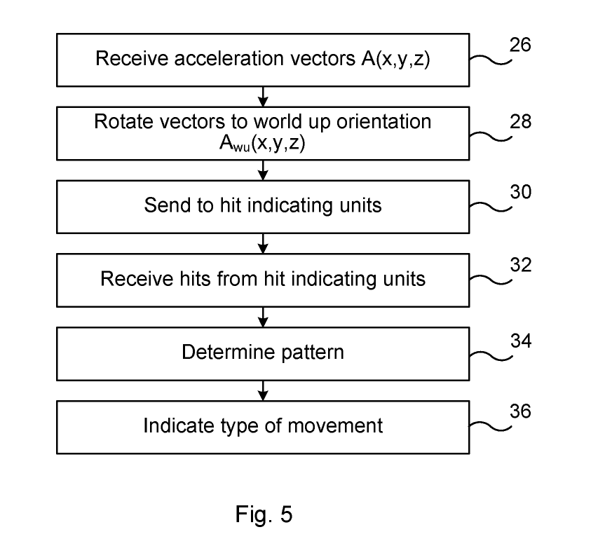

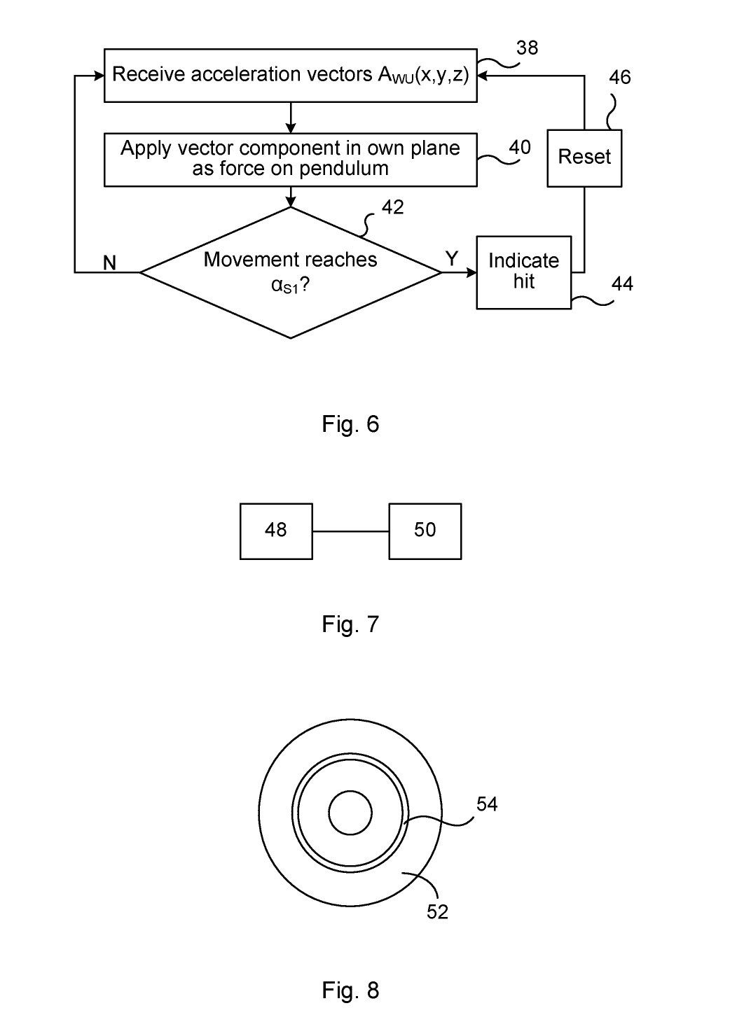

Now a presently preferred embodiment of the invention will be described with reference being made to FIG. 5, which shows a number of method steps performed in the orientation adjusting unit 18 and pattern handling unit 22 of the movement classification device 16, and to FIG. 6, which shows a number of method steps being performed in a hit indicating unit. In this preferred embodiment the pendulum model in FIG. 4 is employed by the hit indicating units, and it is more particularly used in the six different hit indicating units, each providing a pendulum model, where the first hit indicating unit 20A provides a first pendulum used for indicating hits in a first direction in the X-dimension, the second hit indicating unit 20B provides a second pendulum for indicating hits in a second opposite direction in the X-dimension, the third hit indicating unit 20C provides a third pendulum used for indicating hits in a first direction in the Y-dimension, the fourth hit indicating unit 20D provides a fourth pendulum for indicating hits in a second opposite direction in the Y-dimension, the fifth hit indicating unit 20E provides a fifth pendulum used for indicating hits in a first direction in the Z-dimension and the sixth hit indicating unit 20F provides a sixth pendulum for indicating hits in a second opposite direction in the Z-dimension. Furthermore, for each pendulum two stopping angles are set. However, only one is used for indicating a hit. The other is set to reflect movement of the pendulum weight. It thus makes the weight bounce back. In this example the stopping angles are symmetrical and have the same value in relation to the vertical resting position or position of equilibrium of the string S. However, in the two hit indicating units that indicate movement in a dimension one uses the first stopping angle for indicating a hit, while the other uses the second stopping angle. It should here be realized that the stopping angles do not have to be symmetrical.

The accelerometer provides three dimensional acceleration data in the form of acceleration vectors A(x,y,z) at regular recurring points in time. This can be 12 times per second, which means that the time between the acceleration vectors may be 0.083 s. The vectors A(x,y,z) are received by the movement classification device 16, step 26. In this way the movement classification device obtains three-dimensional acceleration data from the accelerometer. In this preferred embodiment they are furthermore received by the orientation adjusting unit 18.

This unit, which is optional, rotates the acceleration vectors, before the processing of the acceleration vectors, to compensate for the accelerometer orientation. This rotation of the vectors may be a rotation so that they are always in the world up direction, step 28. The accelerometer 14 has a coordinate system in which it provides acceleration values. However, this coordinate system depends on the orientation of the accelerometer itself. In some applications this accelerometer may change orientation and therefore the acceleration values may have to be rotated so that they always reflect the same acceleration in relation to a fixed environment such as ground or the earth. In order to do this it is possible to use the knowledge about gravity. Gravity will be present in the vector and the direction of gravity can be deduced from an acceleration vector. This knowledge may then be used for rotating the coordinate system. It is for instance possible to rotate the vector so that gravity points downwards in the Z-dimension. However, this is in fact not a requirement. Other types of rotation can be made. The important thing is that the direction of gravity after rotation is always at a fixed point in the coordinate system. In other situations the accelerometer may have the same orientation all the time, which may be the case in some vehicle applications. In this case no rotation is needed.

After the optional rotation, the vector A_{WU}(x,y,z) is sent to the different hit indicating units, step 30. It is here possible that only the vector component being investigated is sent to a certain hit indicating unit. This means that it is possible that a hit indicating unit investigating the X dimension only receives the X component of an acceleration vector.

Each hit indicating unit thus receives the acceleration vectors, step 38, or at least the components of the acceleration vectors in the dimension that it is investigating. The hit indicating units then process components of the acceleration vectors in at least one dimension in order to obtain dynamic acceleration measures for each dimension being processed. A hit indicating unit having received a vector, then applies the component of the acceleration or force in the dimension in question on the virtual pendulum in the pendulum model, step 40. Initially the pendulum is in a relaxed or inertial position, i.e. in a position of equilibrium, where the weight w stretches vertically down from the pivot point PP. If there is now a force in the dimension being investigated, which is a force in a direction perpendicular to the string orientation of the position of equilibrium, the pendulum will begin to swing. The hit indicating unit now investigates if the movement of the pendulum reaches the first stopping angle α_{S1} and if it does, step 42, then a hit is indicated, step 44, the pendulum reset, step 46, and a new acceleration vector component is received, step 38. However if the stopping angle was not reached, step 42, the pendulum continues swinging and a new vector or component is received, step 38. As the pendulum is swinging it is then possible that this force or a later received force makes the weight reach the stopping angle, at which point in time a hit is indicated. As only one dimension is investigated it is possible that a vector component amounts to zero. There may thus be zero forces between forces that impact the weight.

Each hit indicating unit then continues and receives force components, apply these on the weight of the pendulum model and indicates a hit if a hit indicating stopping angle is reached.

It can thus be seen that the various hit indicating units provide hit indications at various points in time to the pattern handling unit 22.

The pattern handling unit 22 thus receives hit indications from the hit indicating units, step 32. These hits are then combined to form a pattern, step 34. As a pattern is made up of hits in time for a direction in a dimension, the pattern may resemble the musical notes of sheet music, where one line corresponds to one hit indicating unit. This pattern may then be stored in the pattern memory 24. If the pattern is new it may also be classified as corresponding to a certain type of movement. The pattern thus corresponds to a type of movement of the accelerometer. The pattern may also coincide with a previously known and classified pattern being stored in the pattern memory 24. The pattern handling unit 22 may thus compare the pattern with stored patterns in the memory 24 and indicate a type of movement for which the pattern coincides, step 36.

It is also possible that patterns are analyzed and classified through using a classifier such as Bayesian classifier.

It can in this way be seen that various movements generating different hit patterns can be indicated. Furthermore a movement or indication having been classified can with advantage be used in a number of fields.

It is for instance possible to use the classified movement as a command or input to a computer. A classified type of movement may thus as an example be used in controlling some kind of activity in a computer such as an application. If the accelerometer is provided in a smart phone, then it may be used as an input in an application being downloaded to the phone.

If the accelerometer is provided in a vehicle, the classified movement may be used in the control of the vehicle.

The movement classification device may be comprised in a movement classification arrangement. In some variations of the invention the movement classification arrangement only comprises the movement classification device. In other variations it also comprises the accelerometer. The arrangement may furthermore also comprise the equipment or entity in which the accelerometer is provided such as a piece of portable electronic equipment or a vessel.

The movement classification device may be realized in the form of a processor with associated program memory compromising computer program instructions implementing the functionality of the different units. The functionality of the movement classification device, i.e. of these units, is then implemented when the processor runs or acts on the computer program instructions. One such example of a processor 48 and program memory 50 is shown in 7. It can thus be seen that the combination of processor 48 and memory 50 provides the movement classification device. It is possible that the movement classification device is separated from the accelerometer. It may for instance receive acceleration data from the accelerometer via a computer communication network, for instance via the Internet as well as via a mobile communication network, such as LTE, or short-range communication such as Bluetooth.

The computer program code or computer program instructions of the movement classification device may also be in the form of a computer program, such as an app, which may be downloaded to a portable communication device such as a smartphone. The computer program code may also be included in a computer program product for instance in the form of a data carrier, such as a CD ROM disc or a memory stick. In this case the data carrier or memory stick carries a computer program with the computer program code, which will implement the functionality of the above-described movement classification device. One such data carrier 52 with computer program code 54 is schematically shown in FIG. 8 in the form of a CD ROM disk.

As mentioned above the motion data input may be motion data from a gyro or a magnetometer. In the case of a gyro this may deliver motion data that may be directly input to the movement classification device. In the case of a magnetometer the difference between a current motion vector and a previous motion vector may be the three-dimensional motion vector used by the movement classification device.

While the invention has been described in connection with what is presently considered to be most practical and preferred embodiments, it is to be understood that the invention is not to be limited to the disclosed embodiments, but on the contrary, is intended to cover various modifications and equivalent arrangements. Therefore the present invention is only to be limited by the following claims.

1. A method for obtaining a movement pattern associated with a moving entity, the method comprising:
obtaining three-dimensional motion data (A(x,y,z)) at regularly recurring times, said motion data providing three-dimensional motion vectors, processing components of the motion vectors in at least one dimension in order to obtain acceleration measures for each dimension being processed, comparing each acceleration measure with at least one corresponding acceleration measure threshold, indicating a hit for an acceleration measure if a corresponding acceleration measure threshold is crossed, and
providing a pattern of the hits from all processing being made for the dimensions, which pattern corresponds to a type of movement, the processing in a dimension comprising
applying a component of a current motion vector as a force on an imaginary body in a kinematic harmonic oscillation model, and determining the change in movement of the body in relation to the movement of the body caused by previous motion vector components, thereby obtaining the acceleration measure as a position in the path of the oscillatory movement of the body and where the acceleration measure threshold is a maximum allowed end position (αₛ₁, αₛ₂; Xₛ₁) of the body.

2. The method according to claim 1, the processing in a dimension further comprising applying at least one time decay parameter that is a damping parameter of the model.

3. The method according to claim 1, wherein said one or more previous motion vector components are comprised in a previously determined dynamic acceleration measure.

4. The method according to claim 1, wherein the processing in relation to a dimension is made for both directions of the dimension.

5. The method according to claim 4, wherein the processing comprises comparing the measure with a second threshold with opposite polarity than the first threshold and indicating a hit if the second threshold is crossed.

6. The method according to claim 5, wherein the processing comprises two independent processings, each involving a comparison of an independently determined dynamic acceleration measure with a corresponding acceleration measure threshold.

7. The method according to claim 1, wherein the model is a pendulum model.

8. The method according to claim 1, further comprising rotating, before processing the motion vectors, the three-dimensional acceleration vectors to compensate for the accelerometer orientation.

9. The method according to claim 1, wherein the processing is performed in relation to all three dimensions.

10. A movement pattern determining arrangement for obtaining a movement pattern associated with a moving entity and comprising:
a movement classification device configured to obtain three-dimensional motion data (A(x, y, z)) at regularly recurring times, said motion data providing three-dimensional motion vectors, the movement classification device comprising a group of hit indicating units, each being provided for a corresponding dimension and configured to process components of the motion vectors in the dimension in order to obtain acceleration measures, compare an acceleration measure of the dimension with at least one acceleration measure threshold and indicate a hit for the acceleration measure if the acceleration measure threshold is crossed, and
a pattern handling unit configured to provide a pattern of the hits from all processing being made for the dimensions, which pattern corresponds to a type of movement, wherein each hit indicating unit when being configured to process components of motion vectors is further configured to apply a component of a current motion vector as a force on an imaginary body in a kinematic harmonic oscillation model, and
determine the change in movement of the body in relation to the movement of the body caused by previous motion vector components, thereby obtaining an acceleration measure as a position in the path of the oscillatory movement of the body and the acceleration measure threshold is in the form of a maximum allowed end position (αₛ₁, αₛ₂; Xₛ₁) of the body.

11. The movement pattern determining arrangement according to claim 10, further comprising a motion data generating device where the motion data is obtained.

12. The movement pattern determining arrangement according to claim 11, wherein the motion data generating device is an accelerometer providing acceleration data, a gyro providing angular speed data or a magnetometer providing magnetic field direction data.

13. The movement pattern determining arrangement according to claim 10, where a hit indicating unit when being configured to process components of motion vectors is configured to apply at least one time decay parameter that is a damping parameter of the model.

14. The movement pattern determining arrangement according to claim 10, wherein the model is a pendulum model.

15. A non-transitory computer-readable storage medium storing instructions that when executed by a processor cause the computer to perform a method for obtaining a movement pattern associated with a moving entity, the instructions causing a processor of a movement pattern determining arrangement to, when being loaded into a program memory of the movement pattern determining arrangement and run by the processor:
obtain three-dimensional motion data (A(x, y, z)) at regularly recurring times, said motion data providing three-dimensional motion vectors, process components of the motion vectors in at least one dimension in order to obtain acceleration measures for each dimension being processed, compare each acceleration measure with at least one corresponding acceleration measure threshold, indicate a hit for an acceleration measure if a corresponding acceleration measure threshold is crossed, and
provide a pattern of the hits from all processing being made for the dimensions, which pattern corresponds to a type of movement, wherein the processing in one dimension comprises:
applying a component of a current motion vector as a force on an imaginary body in a kinematic harmonic oscillation model, and determine the change in movement of the body in relation to the movement of the body caused by previous motion vector components, thereby obtaining the acceleration measure as a position in the path of the oscillatory movement of the body and where the acceleration measure threshold is a maximum allowed end position (αₛ₁, αₛ₂; Xₛ₁) of the body.

16. (canceled)
